(19) United States
(12) Patent Application Publication
(10) Pub. No.: US 2009/0148086 A1
(43) Pub. Date: Jun. 11, 2009

(54) FAN AND ROTOR OF MOTOR THEREOF

(75) Inventors: Yi-Chen KUO, Taoyuan Hsien (TW); Chia-Chi SHAO, Taoyuan Hsien (TW); Cheng-Wei YAN, Taoyuan Hsien (TW); Te-Tsai CHUANG, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC., Kuei San (TW)

(21) Appl. No.: 12/210,110

(22) Filed: Sep. 12, 2008

(30) Foreign Application Priority Data
Dec. 6, 2007 (TW) 096220687

(51) Int. Cl. F16C 35/00; F04D 25/08

(52) U.S. Cl. 384/440; 417/354

(57) ABSTRACT

A rotor of a motor includes a shaft, a magnetically conductive shell and a connecting element. The shaft has a groove formed at one end of the shaft. The central portion of a top wall of the magnetically conductive shell has at least one extending portion disposed adjacent to the groove, and at least one part of the extending portion is radially projected onto the groove. The connecting element connects the end of the shaft and the extending portion of the magnetically conductive shell. A fan including above-mentioned rotor is also disclosed.

### CROSS REFERENCE TO RELATED APPLICATIONS

This Non-provisional application claims priority under 35 U.S.C. §119(a) on Patent Application No(s). 096220687, filed in Taiwan, Republic of China on Dec. 6, 2007, the entire contents of which are hereby incorporated by reference.

### BACKGROUND OF THE INVENTION

1. Field of Invention

The present invention relates to a fan and a motor thereof, and more particular to a fan and a rotor of a motor thereof.

2. Related Art

Generally speaking, the rotor of a conventional fan is connected to the magnetically conductive shell through a shaft. The shaft passes through the stator of the motor, and the impeller covers the magnetically conductive shell. After accomplishing the assembling, the motor can drive the impeller to rotate so as to operate the fan.

Referring to FIG. 1, a conventional rotor 10 includes a shaft 11, an iron housing 12 and an impeller I. The impeller I has a hub H and a plurality of blades B connected to the hub H. The shaft 11 and the iron housing 12 are connected with each other by the copper sleeve 13, which is riveted with an end 111 of the shaft 11 and the inner side of the central portion of the iron housing 12. The iron housing 12 is telescoped to the hub H.

However, the connection between the iron housing 12 and the copper sleeve 13 is carried out by riveting, and the end 111 of the shaft 11 is a smooth surface, so that the connecting strength between the copper sleeve 13, the shaft 11 and the magnetically conductive shell is insufficient. In addition, the copper sleeve 13 is heavy, and the material and processing costs of the copper sleeve 13 are expensive, so that cost of the rotor 10 is high and its manufacturing process is complicated.

### SUMMARY OF THE INVENTION

In view of the foregoing, the present invention provides a fan and a rotor of a motor thereof, wherein the central portion of a top wall of a magnetically conductive shell has an extending portion disposed adjacent to a groove of a shaft, and an connecting element is provided to connect the magnetically conductive shell and the shaft, so that the connecting strength between the magnetically conductive shell and the shaft can be increased, the manufacturing process can be simplified, and the manufacturing cost can be decreased.

To achieve the above, the present invention discloses a rotor of a motor including a shaft, a magnetically conductive shell and a connecting element. One end of the shaft has a groove. The central portion of a top wall of the magnetically conductive shell has at least one extending portion disposed adjacent to the groove. At least one part of the extending portion is radially projected onto the groove. The connecting element connects the end of the shaft and the extending portion of the magnetically conductive shell.

To achieve the above, the present invention also discloses a fan including an impeller and a motor. The impeller has a hub and a plurality of blades disposed around the hub. The motor is connected with the impeller and drives the impeller to rotate. The motor has a rotor and a stator disposed corresponding to the rotor. The rotor has a shaft, a magnetically shell and a connecting element. One end of the shaft has a groove. The central portion of a top wall of the magnetically conductive shell has at least one extending portion disposed adjacent to the groove. The extending portion is radially projected onto the groove. The connecting element connects the end of the shaft and the extending portion of the magnetically conductive shell.

As mentioned above, the fan and the rotor of its motor according to the present invention have the following features. The central portion of the top wall of the magnetically conductive shell has at least one extending portion disposed adjacent to the groove, and the extending portion is radially projected onto the groove. The relative positions between the connecting element, the extending portion and the groove could be varied depending on actual needs. In comparison with the prior art, the connecting element, the magnetically conductive shell and the shaft of the present invention are connected so as to increase the connecting strength between the magnetically conductive shell and the shaft. In addition, the connecting element, the hub and the blades of the present invention can be formed by molding, so that the manufacturing process is simplified and the manufacturing cost of the fan is decreased.

### BRIEF DESCRIPTION OF THE DRAWINGS

The present invention will be fully understood from the subsequent detailed description and accompanying drawings, which are given by way of illustration only, and thus are not limitative of the present invention, and wherein:

FIG. 1 is a schematic illustration showing a conventional rotor;

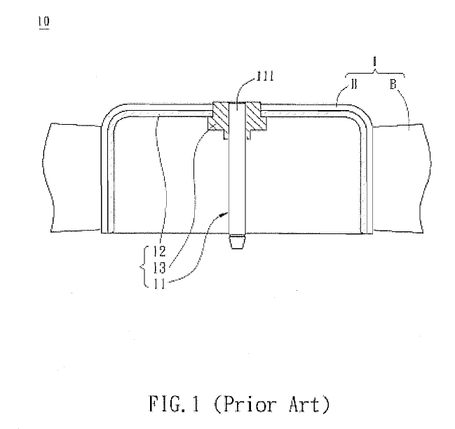

FIG. 2 is a schematic illustration showing a fan according to a first embodiment of the present invention;

FIGS. 3 and 4 are schematic illustrations showing another two types of the rotor in FIG. 2;

FIG. 5 is a schematic illustration showing a fan according to a second embodiment of the present invention;

FIG. 6 is schematic illustration showing another type of the rotor in FIG. 5;

FIG. 7 is a schematic illustration showing a fan according to a third embodiment of the present invention; and

FIGS. 8 and 9 are schematic illustrations showing another two types of the rotor in FIG. 7.

### DETAILED DESCRIPTION OF THE INVENTION

The present invention will be apparent from the following detailed description, which proceeds with reference to the accompanying drawings, wherein the same references relate to the same elements.

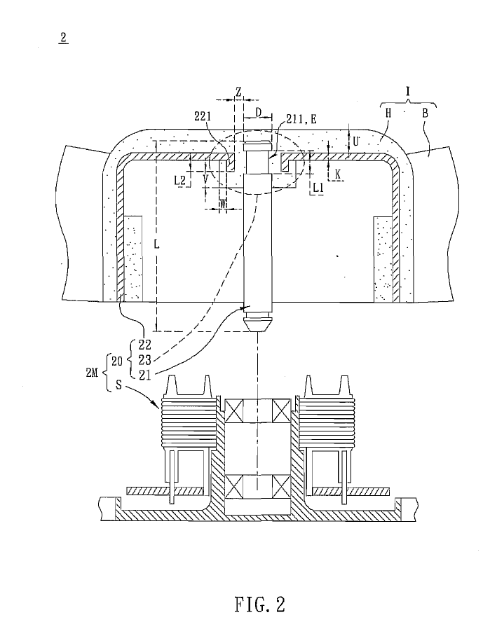

Referring to FIG. 2, a fan 2 according to a first embodiment of the present invention includes an impeller I and a motor 2M. In this embodiment, the fan 2 is an axial fan having an outer-rotor motor. The impeller I has a hub H and a plurality of blades B disposed around the hub H. The motor 2M drives the impeller I to rotate. The motor 2M has a rotor 20 and a stator S disposed corresponding to the rotor 20. The rotor 20 includes a shaft 21, a magnetically conductive shell 22 and a connecting element 23. One end E of the shaft 21 has a groove 211. The central portion of a top wall of the magnetically conductive shell 22 has at least one extending portion 221 disposed adjacent to the groove 211, and at least one part of the extending portion 221 is radially projected onto the groove 211. In other words, at least one part of the extending portion 221 is disposed corresponding to the groove 211.

In this embedment, the extending portion 221 is extended in parallel to the groove 211 and then extended downwards from the central portion of the top wall of the magnetically conductive shell 22. The dimensions of the shaft 21 and the extending portion 221 of the magnetically conductive shell 22 can be configured as follow. The ratio of the length L of the shaft 21 to the length L1 of the groove 211 ranges from 7 to 10. The ratio of the length L1 of the groove 211 to the length L2 of the extending portion 221 preferably ranges from 0.5 to 5. In addition, the ratio of the diameter D of the shaft 21 to the distance Z between the extending portion 221 and the shaft 21 ranges from 0.5 to 5. The dimensions described above can be represented as the following equations:

L=a×L1;

L1=b×L2;

D=c×Z; and

wherein, the coefficient “a” ranges from 7 to 10, the coefficient “b” ranges from 0.5 to 5, and the coefficient “c” ranges from 0.5 to 5.

The connecting element 23 connects the end E of the shaft 21 and the extending portion 221 of the magnetically conductive shell 22. The extending portion 221 can be embedded in or exposed out of the connecting element 23. In this embodiment, the extending portion 221 is embedded in the connecting element 23 for example. The dimensions of the connecting element 23 and the extending portion 221 of the magnetically conductive shell 22 can be configured as follow. The ratio of the radial thickness W of the connecting element 23 covering the extending portion 221 to the thickness K of the magnetically conductive shell 22 ranges from 1 to 5. In addition, the ratio of the distance U between the top surfaces of the connecting element 23 and the magnetically conductive shell 22 to the distance V between the bottom surfaces of the extending portion 221 and the connecting element 23 ranges from 1 to 5. The dimensions described above can be represented as the following equations:

W=d×K;

U=e×V; and

wherein, the coefficient “d” ranges from 1 to 5, and the coefficient “e” ranges from 1 to 5.

In this embedment, the hub H, the blades B and the connecting element 23 are all made of plastic materials, so that the connecting element 23 can be connected to the shaft 21 and the magnetically conductive shell 22, so as to form a monolithic unit. Alternatively, the connecting element 23 can also be connected to the hub H and the blades B to form a monolithic unit. In this case, the connecting element 23 is connected to the shaft 21 and the magnetically conductive shell 22 to form a monolithic unit by insert molding. Thus, the shaft 21 and the magnetically conductive shell 22 can be fixed firmly by the connection of the connecting element 23, thereby increasing the connecting strength between the magnetically conductive shell 22 and the shaft 21.

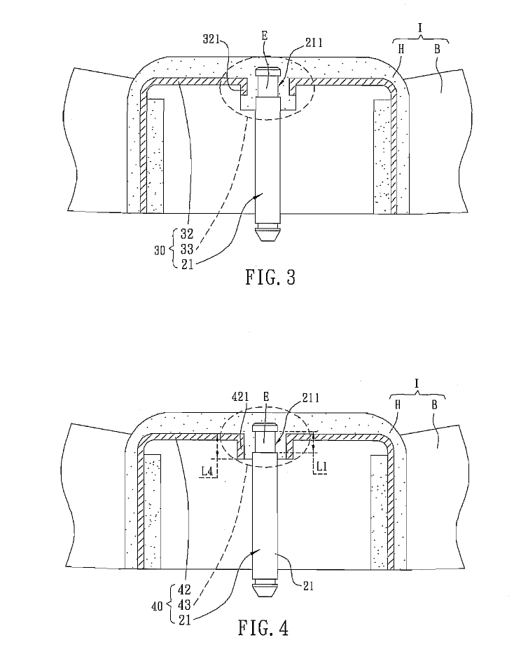

Moreover, the disposition of the impeller I and the rotor could be varied depending on actual needs. For example, as shown in FIG. 3, the extending portion 321 of the magnetically conductive shell 32 of the rotor 30 can be exposed out of the connecting element 33, and the length of the extending portion 321 is equal to the length of the groove 211. Alternatively, as shown in FIG. 4, the extending portion 421 of the magnetically conductive shell 42 of the rotor 40 can be exposed out of the connecting element 43, and the length L4 of the extending portion 421 is lager than the length L1 of the groove 211.

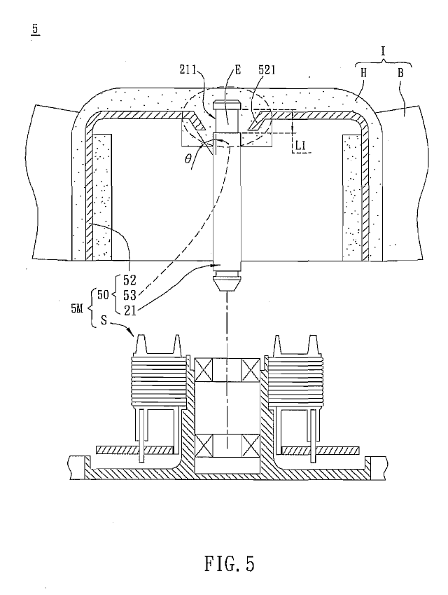

Referring to FIG. 5, a fan 5 according to a second embodiment of the present invention includes an impeller I and a motor 5M. The motor 5M has a rotor 50 and a stator S disposed corresponding to the rotor 50. The rotor 50 includes a shaft 21, a magnetically conductive shell 52, and a connecting element 53. The main structures and functions of the impeller I and the motor 5M are the same as that of the impeller I and the motor 2M of the previous embodiment, so the detailed descriptions are omitted for concise purpose.

The difference between the rotor 20 and the rotor 50 is that the extending portion 521 of the rotor 50 is extended obliquely downwards from the central portion of the top wall of the magnetically conductive shell 52 and embedded in the connecting element 53. An angle θ is formed between the extending direction of the extending portion 521 and the axial direction of the shaft 21. In this case, the angle θ is smaller than 90 degrees. The dimensions of the extending portion 521 of the magnetically conductive shell 52, the length L1 of groove 211 of the shaft 21, and the connecting element 53 are respectively the same as that of the extending portion 221 of the magnetically conductive shell 22, the length L1 of groove 211 of the shaft 21, and the connecting element 23 of the previous embodiment, so the detailed descriptions are omitted for concise purpose.

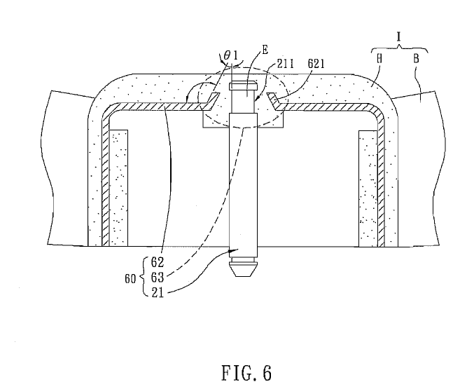

The disposition of the impeller I and the rotor also could be varied depending on actual needs. As shown in FIG. 6, the extending portion 621 of the magnetically conductive shell 62 of the rotor 60 can be extended obliquely upwards from the central portion of the top wall of the magnetically conductive shell 62 and embedded in the connecting element 63. Accordingly, an angle θ1 is formed between the extending portion 621 and the shaft 21.

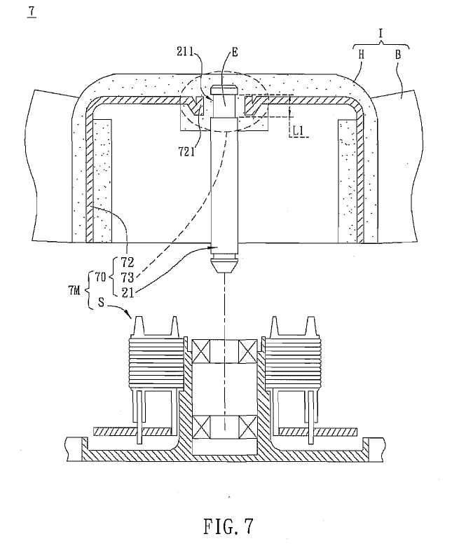

Referring to FIG. 7, a fan 7 according to a third embodiment of the present invention includes an impeller I and a motor 7M. The motor 7M has a rotor 70 and a stator S disposed corresponding to the rotor 70. The rotor 70 includes a shaft 21, a magnetically conductive shell 72, and a connecting element 73. The main structures and functions of the impeller I and the motor 7M are the same as that of the impeller I and the motor 5M of the previous embodiment, so the detailed descriptions are omitted for concise purpose.

The difference between the rotor 50 and the rotor 70 is that the extending portion 721 of the rotor 70 is extended obliquely downwards from the central portion of the top wall of the magnetically conductive shell 72, and then extended upwards with parallel to the groove 211 so as to form a turn. Herein, the extending portion 721 is embedded in the connecting element 73. The dimensions of the extending portion 721 of the magnetically conductive shell 72, the length L1 of the groove 211 of the shaft 21, and the connecting element 73 are respectively the same as that of the extending portion 521 of the magnetically conductive shell 52, the length L1 of groove 211 of the shaft 21, and the connecting element 53 of the previous embodiment, so the detailed descriptions are omitted for concise purpose.

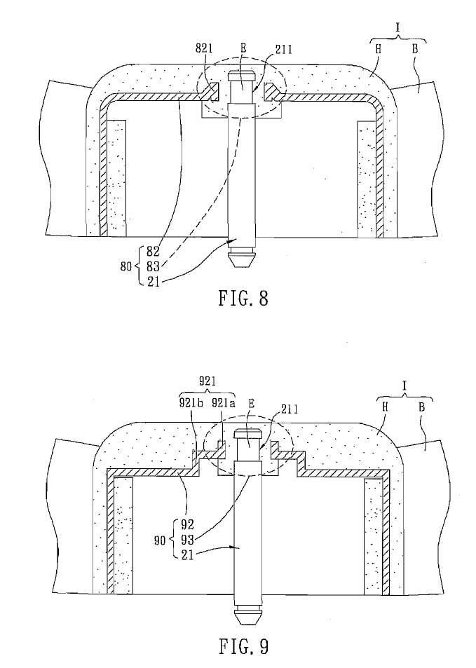

Also, the disposition of the impeller I and the rotor could be varied depending on actual needs. For example, as shown in FIG. 8, the extending portion 821 of the magnetically conductive shell 82 of the rotor 80 can be extended obliquely upwards from the central portion of the top wall of the magnetically conductive shell 82 and then extended downwards with parallel to the groove 211 so as to form a turn. Herein, the extending portion 821 is embedded in the connecting element 83. Alternatively, as shown in FIG. 9, the extending portion 921 of the magnetically conductive shell 92 of the rotor 90 can be extended upwards or downwards from the central portion of the top wall of the magnetically conductive shell 92 and forms a first turn 921a and a second turn 921b. Herein, the first turn 921a is embedded in the connecting element 93, and the second turn 921b is exposed out of the connecting element 93. Thus, the connecting strength between the magnetically conductive shell 92 and the shaft 21 can be increased.

In summary, the fan and the rotor of its motor according to the present invention have the following features. The central portion of the top wall of the magnetically conductive shell has at least one extending portion disposed adjacent to the groove, and the extending portion is radially projected onto the groove. The relative positions between the connecting element, the extending portion and the groove could be varied depending on actual needs. In comparison with the prior art, the connecting element, the magnetically conductive shell and the shaft of the present invention are connected so as to increase the connecting strength between the magnetically conductive shell and the shaft. In addition, the connecting element, the hub and the blades of the present invention can be formed by molding so as to simplify the manufacturing process and decrease the manufacturing cost of the fan.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A rotor of a motor, the rotor comprising:
a shaft having a groove formed at one end of the shaft;
a magnetically conductive shell having at least one extending portion formed at a central portion of a top wall thereof, wherein the extending portion is disposed adjacent to the groove, and at least one part of the extending portion is radially projected onto the groove; and
a connecting element connecting the end of the shaft and the extending portion of the magnetically conductive shell.

2. The rotor according to claim 1, wherein a ratio of a length of the groove to a length of the extending portion ranges from 0.5 to 5.

3. The rotor according to claim 1, wherein a ratio of a diameter of the shaft to a distance between the extending portion and the shaft ranges from 0.5 to 5.

4. The rotor according to claim 1, wherein a ratio of a length of the shaft to a length of the groove ranges from 7 to 10.

5. The rotor according to claim 1, wherein a ratio of a distance between a top surface of the connecting element and a top surface of the magnetically conductive shell to a distance between a bottom surface of the extending portion and a bottom surface of the connecting element ranges from 1 to 5.

6. The rotor according to claim 1, wherein the extending portion is embedded in or exposed out of the connecting element.

7. The rotor according to claim 6, wherein when the extending portion is embedded in the connecting element, a ratio of a radial thickness of the connecting element covering the extending portion to a thickness of the magnetically conductive shell ranges from 1 to 5.

8. The rotor according to claim 1, wherein an extending direction of the extending portion and an axial direction of the shaft are in parallel or form an angle which is smaller than 90 degrees.

9. The rotor according to claim 1, wherein the connecting element is connected to the shaft and the magnetically conductive shell by insert molding, and the connecting element comprises a plastic material.

10. The rotor according to claim 1, wherein a length of the extending portion is equal to or larger than that of the groove.

11. The rotor according to claim 1, wherein the extending portion has at least one turn.

12. The rotor according to claim 11, wherein the extending portion is extended obliquely downwards from a central portion of a top wall of the magnetically conductive shell and then extended upwards with parallel to the groove so as to form the turn.

13. The rotor according to claim 11, wherein the extending portion is extended obliquely upwards from a central portion of a top wall of the magnetically conductive shell and then extended downwards with parallel to the groove so as to form the turn.

14. The rotor according to claim 11, wherein the extending portion is extended upwards or downwards from a central portion of a top wall of the magnetically conductive shell, and then forms a first turn and a second turn.

15. A fan, comprising:
an impeller having a hub and a plurality of blades disposed around the hub; and
a motor driving the impeller to rotate, wherein the motor has a rotor and a stator disposed corresponding to the rotor, and the rotor comprises:
a shaft having a groove formed at one end of the shaft,
a magnetically conductive shell having at least one extending portion formed at a central portion of a top wall thereof, wherein the extending portion is disposed adjacent to the groove, at least one part of the extending portion is radially projected onto the groove, and the hub is telescoped to the magnetically conductive shell, and
a connecting element connecting the end of the shaft and the extending portion of the magnetically conductive shell.

16. The fan according to claim 15, wherein the hub, the blades and the connecting element are integrally formed as a monolithic unit.

17. The fan according to claim 15, wherein the extending portion of the magnetically conductive shell is embedded in or exposed out of the connecting element.

18. The fan according to claim 15, wherein the connecting element is connected to the shaft and the magnetically conductive shell by insert molding, and the connecting element comprises a plastic material.

19. The fan according to claim 15, wherein the extending portion has at least one turn.

20. The fan according to claim 19, wherein the extending portion is extended obliquely downwards or upwards from a central portion of a top wall of the magnetically conductive shell and then extended upwards or downwards with parallel to the groove so as to form the turn, or the extending portion is extended upwards or downwards from a central portion of a top wall of the magnetically conductive shell and then forms a first turn and a second turn.
